(19) United States
(12) Patent Application Publication
(10) Pub. No.: US 2019/0171800 A1
(43) Pub. Date: Jun. 6, 2019

(54) FRONT DESK SYSTEM AUTO LOGOFF USING BIOMETRICS SOFTWARE AND BLUETOOTH COMMUNICATION

(71) Applicant: Carrier Corporation, Jupiter, FL (US)

(72) Inventors: Sumanth Kumar Mukundala, Hyderabad (IN); Adam Kuenzi, Silverton, OR (US)

(21) Appl. No.: 15/887,396

(22) Filed: Feb. 2, 2018

(30) Foreign Application Priority Data
Dec. 5, 2017 (IN) 201711043646

(51) Int. Cl. G06F 21/31; G06K 9/00; G06F 11/30; G06F 21/32

(52) U.S. Cl. CPC G06F 21/316; G06F 21/32; G06F 11/3055; G06K 9/00221

(57) ABSTRACT

A method is provided. The method includes capturing, by a detection device coupled to a computer, characteristics of a target. The method includes looping, by the computer, an inactivity timer with respect to whether the characteristics are detected by the detection device. The method includes automatically executing, by the computer, a temporary logoff operation of a user at a conclusion of the inactivity timer. The method includes initiating, by the computer, an operation of a logoff timer in response to the execution of the temporary logoff operation. The method includes automatically executing, by the computer, a login operation of the user when the characteristics are redetected by the detection device during the operation of the logoff timer.

### BACKGROUND

Conventional front desk systems logoff when there is no action or no performance in an application based on a logoff timer. For instance, if a front desk clerk logs onto a conventional front desk system and subsequently stops using the conventional front desk system, the logoff timer will count (e.g., for 10 minutes). Providing that there is no action or no performance in application (e.g. from a mouse movement or keystrokes on a keyboard) between the start and end of the count, the logoff timer will automatically log off at the count's conclusion. A problem exists when the front desk clerk steps away from the conventional front desk system. Since the log off is timer based and is usually long enough for the convenience of the front desk clerk, the conventional front desk system is exposed to someone who can come and encode a card and go without receptionist notice.

### BRIEF DESCRIPTION

In accordance with one or more embodiments, a method is provided. The method includes capturing, by a detection device coupled to a computer, characteristics of a target. The method includes looping, by the computer, an inactivity timer with respect to whether the characteristics are detected by the detection device. The method includes automatically executing, by the computer, a temporary logoff operation of a user at a conclusion of the inactivity timer. The method includes initiating, by the computer, an operation of a logoff timer in response to the execution of the temporary logoff operation. The method includes automatically executing, by the computer, a login operation of the user when the characteristics are redetected by the detection device during the operation of the logoff timer.

In accordance with one or more embodiments or the method embodiment above, the detection device can include an optical device, the target can include the user, and the characteristics can include distinguishing features of a face of the user.

In accordance with one or more embodiments or any of the method embodiments above, the detection device can include an optical device, the target can include one or more objects on the user, and the characteristics can include distinguishing features of the one or more objects on the user.

In accordance with one or more embodiments or any of the method embodiments above, the detection device can include a transceiver, the target can include a wireless beacon on the user, and the characteristics can include a unique wireless signal outputted by the wireless beacon and detectable by the transceiver.

In accordance with one or more embodiments or any of the method embodiments above, the detection by the detection device of the characteristics of the target can cause a resetting of the inactivity timer.

In accordance with one or more embodiments or any of the method embodiments above, the computer can execute an initial login operation of the user in response to receiving user credentials and can associate the characteristics of the target with the user credentials.

In accordance with one or more embodiments or any of the method embodiments above, the computer can execute a full logout operation of the user at a conclusion of the logoff timer.

In accordance with one or more embodiments, a detection system is provided. The detection system includes a computer and a detection device. The computer includes a memory and a processor. The memory stores program instructions thereon. The program instructions are executable by the processor to cause capturing, by the detection device coupled to the computer, characteristics of a target. The program instructions are executable by the processor to cause looping, by the computer, an inactivity timer with respect to whether the characteristics are detected by the detection device. The program instructions are executable by the processor to cause automatically executing, by the computer, a temporary logoff operation of a user at a conclusion of the inactivity timer. The program instructions are executable by the processor to cause initiating, by the computer, an operation of a logoff timer in response to the execution of the temporary logoff operation. The program instructions are executable by the processor to cause automatically executing, by the computer, a login operation of the user when the characteristics are redetected by the detection device during the operation of the logoff timer.

In accordance with one or more embodiments or the detection system embodiment above, the detection device can include an optical device, the target can include the user, and the characteristics can include distinguishing features of a face of the user.

In accordance with one or more embodiments or any of the detection system embodiments above, the detection device can include an optical device, the target can include one or more objects on the user, and the characteristics can include distinguishing features of the one or more objects on the user.

In accordance with one or more embodiments or any of the detection system embodiments above, the detection device can include a transceiver, the target can include a wireless beacon on the user, and the characteristics can include a unique wireless signal outputted by the wireless beacon and detectable by the transceiver.

In accordance with one or more embodiments or any of the detection system embodiments above, the detection by the detection device of the characteristics of the target can cause a resetting of the inactivity timer.

In accordance with one or more embodiments or any of the detection system embodiments above, the computer can execute an initial login operation of the user in response to receiving user credentials and can associate the characteristics of the target with the user credentials.

In accordance with one or more embodiments or any of the detection system embodiments above, the computer can execute a full logout operation of the user at a conclusion of the logoff timer.

In accordance with one or more embodiments, a computer program product is provided. The computer program product includes a computer readable storage medium having program instructions embodied therewith. The program instructions are executable by a computer coupled to a detection device to cause capturing, by the detection device coupled to the computer, characteristics of a target. The program instructions are executable by the computer coupled to the detection device to cause looping, by the computer, an inactivity timer with respect to whether the characteristics are detected by the detection device. The program instructions are executable by the computer coupled to the detection device to cause automatically executing, by the computer, a temporary logoff operation of a user at a conclusion of the inactivity timer. The program instructions are executable by the computer coupled to the detection device to cause initiating, by the computer, an operation of a logoff timer in response to the execution of the temporary logoff operation. The program instructions are executable by the computer coupled to the detection device to cause automatically executing, by the computer, a login operation of the user when the characteristics are redetected by the detection device during the operation of the logoff timer.

In accordance with one or more embodiments or the computer program product embodiment above, the detection device can include an optical device, the target can include the user, and the characteristics can include distinguishing features of a face of the user.

In accordance with one or more embodiments or any of the computer program product embodiments above, the detection device can include an optical device, the target can include one or more objects on the user, and the characteristics can include distinguishing features of the one or more objects on the user.

In accordance with one or more embodiments or any of the computer program product embodiments above, the detection device can include a transceiver, the target can include a wireless beacon on the user, and the characteristics can include a unique wireless signal outputted by the wireless beacon and detectable by the transceiver.

In accordance with one or more embodiments or any of the computer program product embodiments above, the detection by the detection device of the characteristics of the target can cause a resetting of the inactivity timer.

In accordance with one or more embodiments or any of the computer program product embodiments above, the computer can execute an initial login operation of the user in response to receiving user credentials and can associate the characteristics of the target with the user credentials.

In accordance with one or more embodiments or any of the computer program product embodiments above, the computer can execute a full logout operation of the user at a conclusion of the logoff timer.

### BRIEF DESCRIPTION OF THE DRAWINGS

The following descriptions should not be considered limiting in any way. With reference to the accompanying drawings, like elements are numbered alike:

FIG. 1 depicts a detection system according to one or more embodiments;

FIG. 2 depicts a process flow of a detection system according to one or more embodiments;

FIG. 3 depicts a detection system according to one or more embodiments; and

FIG. 4 depicts a detection system according to one or more embodiments.

### DETAILED DESCRIPTION

A detailed description of one or more embodiments of the disclosed apparatus and method are presented herein by way of exemplification and not limitation with reference to the Figures.

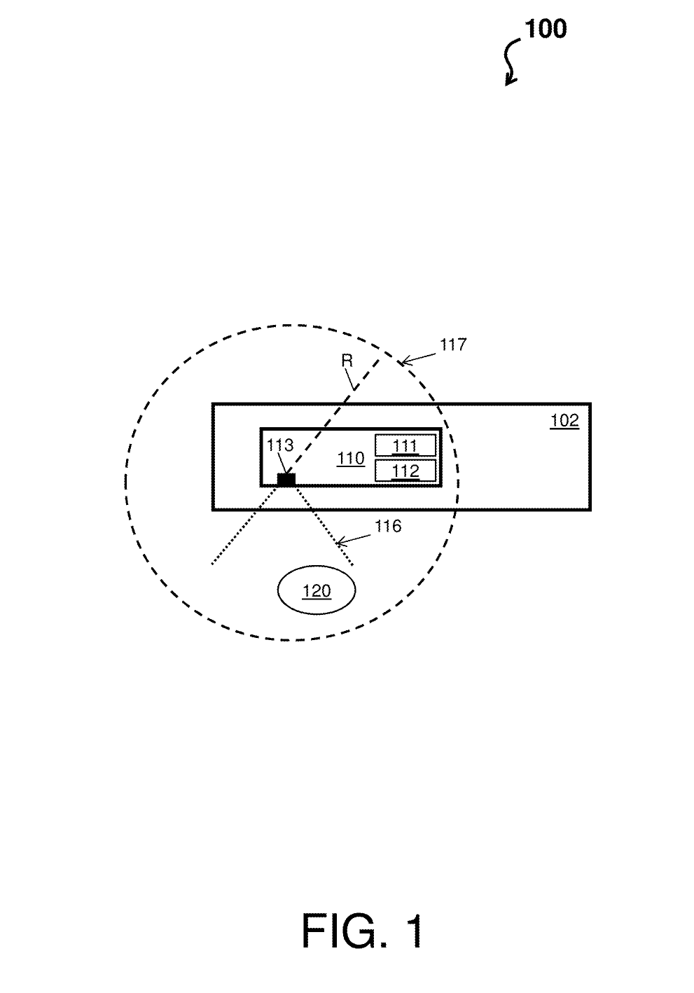

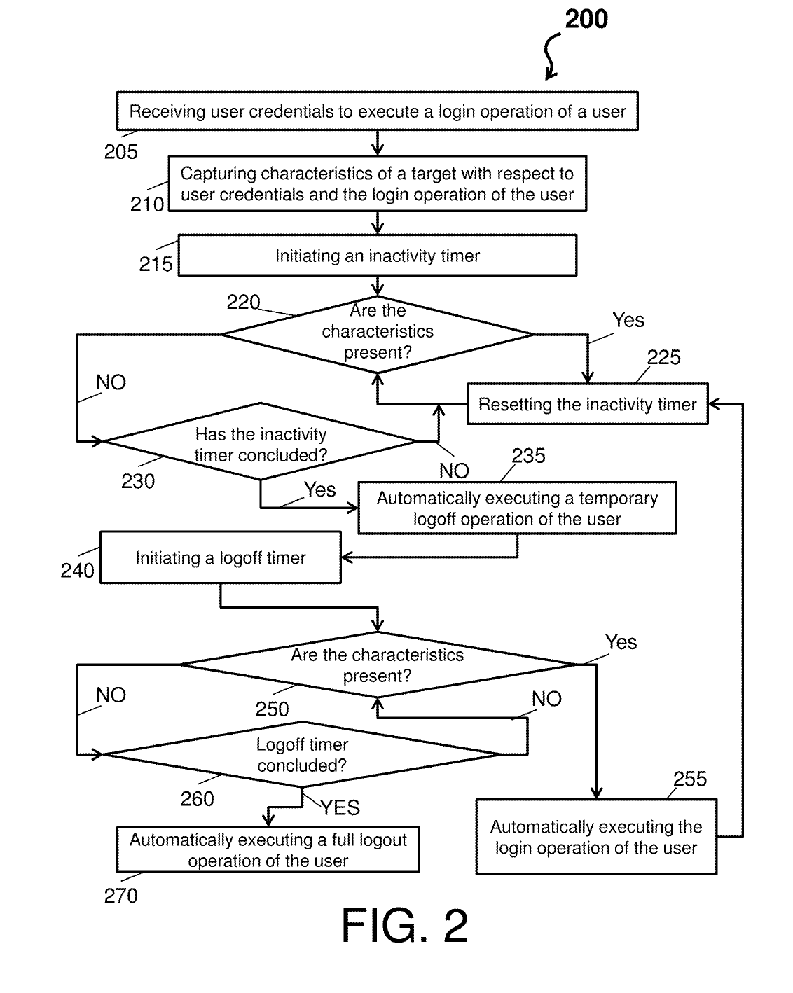

In accordance with one or more embodiments, a system comprises one or more detection devices that detect a target with respect to whether a user remains logged-in. The system can be implemented as a method, computer program product, and/or a device, and is further described herein with respect to, but not limited thereto, a reception desk example. The system will now be described with respect to FIGS. 1-2.

FIG. 1 depicts a detection system 100 according to one or more embodiments. The detection system 100 can be implemented at a reception desk 102 and comprise at least a computer 110. The computer 110 can comprise a processor 111, a memory 112, and a detection device 113. The detection device 113 can be built-in to the computer 110 or it can be a peripheral of the computer and connected via wireless or wired means to the computer (e.g. through a USB connection or Wi-Fi, Bluetooth, or the like). The memory 112 of the detection system 100 stores program instructions that are executable by the processor 111 to cause the operation described herein. The detection device 113 can maintain one or more detection zones (e.g., a first detection zone 116 and a second detection zone 117) within which characteristics of a target 120 are captured and detected. In accordance with one or more embodiments, the target 120 can be a user themselves (e.g., a user's face), an object on the user (e.g., a name plate), a device on the user (e.g., a Bluetooth beacon or mobile phone), and the like.

In general, the detection system 100 operates to immediately logoff of the computer 110 a user when that user is away from the detection system 100, while still providing a user friendly mechanism for the user to log back on to the computer 110. For example, upon the user logging-in, the detection device 113 captures characteristics of the target 120 associated with the user (not shown) that is logging-in and provides these characteristics to the software on the computer 110. The computer 110 then loops an inactivity timer with respect to whether the characteristics are subsequently detected by the detection device 110. At a conclusion of the inactivity timer, the computer 110 automatically executes a temporary logoff operation of the user if the characteristics have not been detected. Then, the computer 110 initiates a logoff timer in response to the execution of the temporary logoff operation and only automatically executes a login operation of the user when the characteristics are redetected by the detection device 113 during the operation of the logoff timer. In accordance with one or more embodiments, the inactivity timer may be configured to execute a temporary logoff operation much sooner than a conventional inactivity timer that was based on mouse movement or keyboard use by a user. This leads to the technical effect and benefit of higher security. The temporary logoff timer allows for the convenience of the user returning to the computer 110 and may be a similar length to a conventional inactivity timer so that the overall convenience of the user is about the same with respect to how often the user needs to re-login and submit their respective user credentials. Further, the temporary logoff increases security because someone cannot use the computer 110 unless they are the same user or they execute a full new login as a different user.

The detection system 100 is an example and is not intended to suggest any limitation as to the scope of use or operability of embodiments described herein (indeed additional or alternative components and/or implementations may be used). Further, while single items are illustrated for items of the detection system 100, these representations are not intended to be limiting and thus, any item may represent a plurality of items.

The computer 110 can include any processing hardware, software, or combination of hardware and software utilized by the detection system 100 to carry out computer readable program instructions by performing arithmetical, logical, and/or input/output operations. The computer 110 operates to provide front desk and reception services to customer, along with transmit and receive communications to and from the detection device 113. The computer 110 operates one or more timers (e.g., an inactivity timer and a logoff timer) with respect to the operations described herein. The processor 111 can comprise one or more central processing units (CPU(s)), also referred to as processing circuits, coupled via a system bus to the memory 112 and various other components (e.g., the detection device 113). The memory 112 can include a read only memory (ROM) and a random access memory (RAM). In accordance with one or more embodiments, the computer 110 can record in a log of the memory 112 when a user logs in or out with respect to the first login, the temporary logouts based on the inactivity timer, the automatic logins based on the detection of the target 120, etc. In this regard, when a valid user successfully logs into or out of the detection system 100, the log can generate a line indicating a user name date and time stamp.

The detection device 113 can be an electro-mechanical component that detects events in an environment and generates an electrical signal as a function of the events (e.g., generates an electrical signal in response to detecting characteristics of the target 120). The detection device 113 can utilize software and/or firmware to carry out operations particular thereto. The software and/or firmware utilized by the detection device 113 can be provided with respect to continuously sensing characteristics of the target 120. In accordance with one or more embodiments, the detection device can include an optical device (e.g., a camera), the target can include the user, and the characteristics can include distinguishing features of a face of the user. In accordance with one or more embodiments, the detection device 113 can include an optical device, the target can include one or more objects on the user (e.g., a shirt or a name tag), and the characteristics can include distinguishing features of the one or more objects on the user (e.g., a distinguishing logo or the characters of the name, or a color pattern or hue of their clothing). In accordance with one or more embodiments or any of the method embodiments above, the detection device can include a transceiver (e.g., communications and/or interface adapter), the target can include a wireless beacon on the user (e.g., an electronic bracelet), and the characteristics can include a unique wireless signal outputted by the wireless beacon and detectable by the transceiver. In accordance with one or more embodiments, the unique signal may be prior associated with a user account. In accordance with one or more embodiments, the unique signal is detected at the time of login and associated with the user only during this login session. In accordance with one or more embodiments, the detection device 113 is a microphone (e.g., transducer that converts the sound waves into an electrical signal) coupled to a transceiver that communicates the sound waves as the electrical signal to the computer 110.

The first detection zone 116 and the second detection zone 117 are operation areas to and from which the target 120 can move. In the case of when the detection device 113 is an optical device, the first detection zone 116 can be a field of view of the optical device. In the case of when the detection device 113 is a transceiver, the second detection zone 117 can be a detection area defined by a radius R. Note that the either detection zone 116 and 117 can comprise or overlap with a wide area network designed for communications with the target 120 (e.g., any wireless communication architecture, such as Bluetooth, Wi-Fi, ZigBee, etc.) or computer 110.

FIG. 2 depicts a process flow 200 of the detection system 100 according to one or more embodiments. The process flow begins at block 205, where the detection system 100 receives user credentials to execute a login operation of a user. The user credentials can include a username and a password unique to the user logging-in, or be of any other form for identifying and verifying a user with a computer software program. The login operation can include an operation by the computer 110 that provides a unique interface tailored to the user providing the user credentials.

At block 210, the detection system 100 captures characteristics of a target 120 with respect to the user credentials and the login operation of the user. The characteristics can correspond to distinguishing features of the user's face, of a name tag, of a radio signal, etc. At block 215, the detection system 100 initiates an inactivity timer. The inactivity timer is a mechanism that tracks an amount of time in which no activity has taken place with respect to the computer 110. The inactivity timer counts, either up or down, to a predefined variable. The predefined variable is a time limit that can be set by an administrator, such as 10 seconds, 30 seconds, 60 seconds, 2 minutes, 5 minutes, 10 minutes, and the like (e.g., any time greater than zero).

At decision block 220, the detection device 113 determines whether any characteristics are present (e.g., within one or more detection zones). For example, the computer 110 can compare a first image taken at login by the detection device 113 with a subsequent image taken when the user approaches the computer 110. The comparison can include facial recognition techniques that compare facial characteristics of each image and/or detecting identifiers (e.g., characteristics) off a name badge between the first and subsequent image. If the detection device 113 determines that the characteristics of the target 120 are present, then the process flow 200 proceeds to block 225 (e.g., as indicated by the YES arrow). At block 225, the detection system 100 resets the inactivity time. In this regard, it is clear that the user is still local to the computer 110 and, thus, the threat to an unauthorized person using the computer 110 is low. After block 225, the process flow 200 returns to decision block 220. If the detection device 113 determines that the characteristics of the target 120 are not present, then the process flow 200 proceeds to decision block 230 (e.g., as indicated by the NO arrow).

At decision block 230, the detection system 100 determines whether the inactivity timer has concluded. If the detection system 100 determines that the inactivity timer has not concluded, then the process flow 200 proceeds back to decision block 220 (e.g., as indicated by the NO arrow). In this regard, the user has not been absent from the computer 110 for a sufficient amount of time to warrant a logoff. If the detection system 100 determines that the inactivity timer has concluded, then the process flow 200 proceeds to block 235 (e.g., as indicated by the YES arrow).

At block 235, the detection system 100 automatically executes a temporary logoff operation of the user. In this regard, it is clear that the user is still away from the computer 110 and has been for a significant amount of time. Thus, the threat to an unauthorized person using the computer 110 is high. At block 240, the detection system 100 initiates a logoff timer.

At decision block 250, the detection device 113 determines whether any characteristics are present (e.g., within one or more detection zones). If the detection device 113 determines that the characteristics of the target 120 are present, then the process flow 200 proceeds to block 255 (e.g., as indicated by the YES arrow). At block 255, the detection system 100 automatically executes the login operation of the user. In this regard, it is clear that the user has return to the computer 110 and rather than require the manual entry of the previous user credentials, the computer 110 can automatically logon the user based on the characteristics of the target 120 being present. After block 255, the process flow 200 returns to block 225. If the detection device 113 determines that the characteristics of the target 120 are not present, then the process flow 200 proceeds to decision block 260 (e.g., as indicated by the NO arrow).

At decision block 260, the detection system 100 determines whether the logoff timer has concluded. If the detection system 100 determines that the logoff timer not has concluded, then the process flow 200 proceeds back to decision block 250 (e.g., as indicated by the NO arrow). If the detection system 100 determines that the logoff timer has concluded, then the process flow 200 proceeds to block 270 (e.g., as indicated by the YES arrow). At block 270, the detection system 100 automatically executes a full logout operation of the user. At this stage, the computer 110 will require the manual entry of any user credentials for access to the computer 110 to be granted.

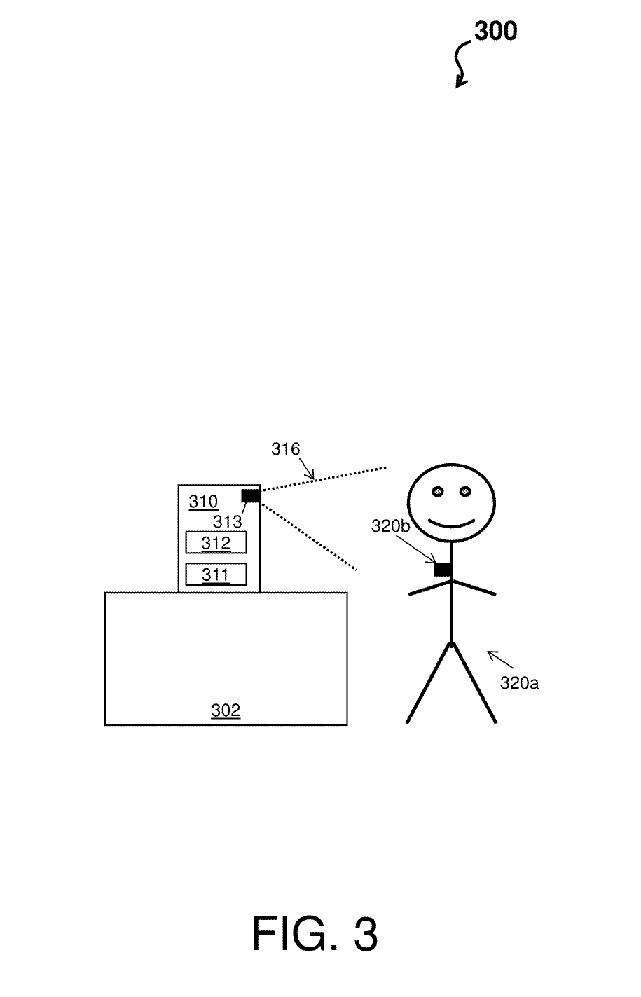

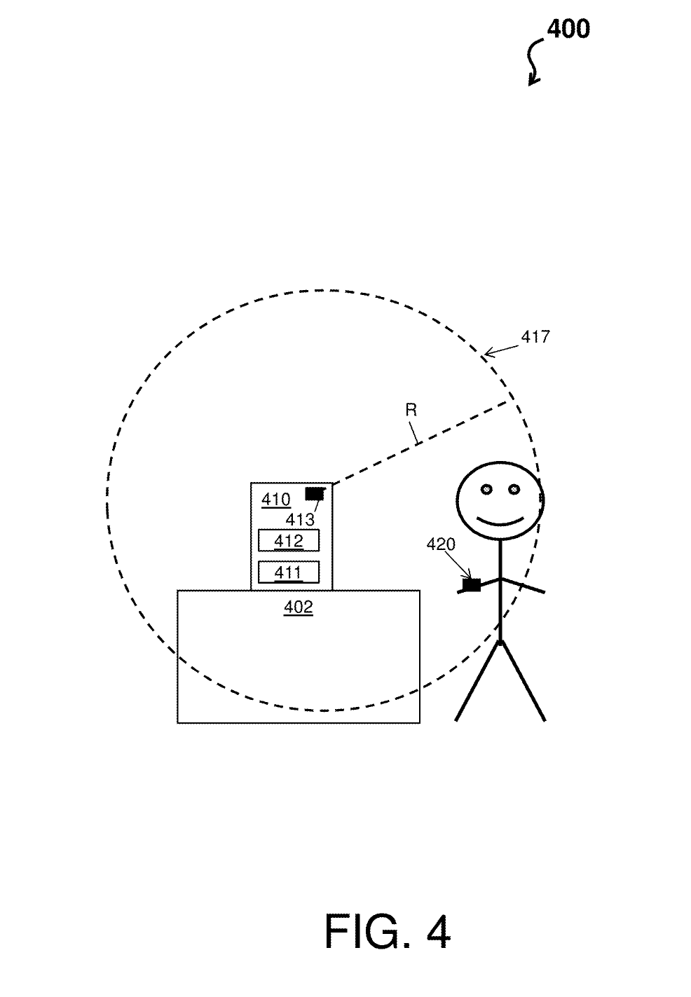

Turning now to FIG. 3-4, the above detection system will now be further described. FIG. 3 depicts a detection system 300 using biometrics according to one or more embodiments. The detection system 300 can be implemented at a reception desk 302 and comprise at least a computer 310. The computer 310 can comprise a processor 311, a memory 312, and a detection device 313 (e.g., camera). The memory 312 of the detection system 300 stores program instructions that are executable by the processor 311 to cause the operation described herein. The detection device 313 can maintain a detection zone 316 (e.g., a field of view) within which one or more targets 320a and 320b can be captured and detected (where target 320a is a user and target 320b is a name tag).

In general, the detection system 300 can operate facial recognition, e.g., biometrics software as a service. In this regard, a user can login into the computer 310 using their user credentials and, after successfully logging-in to the computer 310, an internal facial recognition software of the computer 310 initiates and tracks the user's face or the name tag characters (e.g., using the detection device 313). Thus, when the user goes away from the computer 310, the computer 310 automatically logs-off and will only automatically log-on (without a manual login) if the same user returns to the computer 310 and is identified by the facial recognition software. In this example, the user is not initially identified by the facial recognition software, but rather they are identified with their normal user account identification and then authenticated by their account password. Further, the facial characteristics that are captured as part of process flow 200 at block 210 may only be temporarily associated with the current user that is logged into the computer 110. After the logoff timer expires (block 270) the characteristics captured in block 210 may be forgotten by the computer 110. Thus, the facial recognition ensures that the same person that logged in is continuing to use the software. If the person changes from a first user to a second user, the facial recognition software determines the change and the computer 310 will automatically log-off. If the user logs in a first time, but then leaves the detection zone 316 then the computer 310 will automatically log-off. Later, if the user returns at some later time and logs-in a second time, but they are wearing different clothing, or they have altered their face (e.g. by shaving) the detection device 313 will possibly identify different characteristics of the user that may on the second login from the first login. One example of a different characteristic is the color tone of their clothing.

FIG. 4 depicts a detection system 400 using Bluetooth communication according to one or more embodiments. The detection system 400 can be implemented at a reception desk 402 and comprise at least a computer 410. The computer 410 can comprise a processor 411, a memory 412, and a detection device 413 (e.g., transceiver). The memory 412 of the detection system 400 stores program instructions that are executable by the processor 411 to cause the operation described herein. The detection device 410 can maintain a detection zone 417 with a radius R (e.g., a detection area) within which one or more targets 420 can be captured and detected (where target 420 is a bracelet or Bluetooth wearable badge).

In general, each user interacting with the detection system 400 can have a corresponding Bluetooth wearable badge 420 that can be applied or fixed to a shirt during working hours. A user can login into the computer 410 using their user credentials and, after successfully logging-in to the computer 410, the corresponding Bluetooth wearable badge 420 will advertise and communicate the computer 410. Thus, when the user goes away from the computer 410, the computer 410 automatically logs-off and will only automatically log-on (without a manual login) if the same user having the same badge 420 returns to the computer 410 and is identified by the corresponding Bluetooth wearable badge 420.

In view of the above, the technical effects and benefits of the system described herein include a fully secured system only accessed by authorized staff via face detection or Bluetooth communication, such that a receptionist need not worry if they temporarily forgot to lock a computer or logoff when they step away (indeed the system will automatically logoff).

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A computer-implemented method comprising:
capturing, by a detection device coupled to a computer, characteristics of a target;
looping, by the computer, an inactivity timer with respect to whether the characteristics are detected by the detection device;
automatically executing, by the computer, a temporary logoff operation of a user at a conclusion of the inactivity timer;
initiating, by the computer, an operation of a logoff timer in response to the execution of the temporary logoff operation;
automatically executing, by the computer, a login operation of the user when the characteristics are redetected by the detection device during the operation of the logoff timer.

2. The computer-implemented method of claim 1, wherein the detection device comprises an optical device, the target comprises the user, and the characteristics comprise distinguishing features of a face of the user.

3. The computer-implemented method of claim 1, wherein the detection device comprises an optical device, the target comprises one or more objects on the user, and the characteristics comprise distinguishing features of the one or more objects on the user.

4. The computer-implemented method of claim 1, wherein the detection device comprises a transceiver, the target comprises a wireless beacon on the user, and the characteristics comprise a unique wireless signal outputted by the wireless beacon and detectable by the transceiver.

5. The computer-implemented method of claim 1, wherein the detection by the detection device of the characteristics of the target causes a resetting of the inactivity timer.

6. The computer-implemented method of claim 1, wherein the computer executes an initial login operation of the user in response to receiving user credentials and associates the characteristics of the target with the user credentials.

7. The computer-implemented method of claim 1, wherein the computer executes a full logout operation of the user at a conclusion of the logoff timer.

8. A detection system comprising a computer and a detection device, the computer comprising a memory and a processor, the memory storing program instructions thereon, the program instructions executable by the processor to cause:
capturing, by the detection device coupled to the computer, characteristics of a target;
looping, by the computer, an inactivity timer with respect to whether the characteristics are detected by the detection device;
automatically executing, by the computer, a temporary logoff operation of a user at a conclusion of the inactivity timer;
initiating, by the computer, an operation of a logoff timer in response to the execution of the temporary logoff operation;
automatically executing, by the computer, a login operation of the user when the characteristics are redetected by the detection device during the operation of the logoff timer.

9. The detection system of claim 8, wherein the detection device comprises an optical device, the target comprises the user, and the characteristics comprise distinguishing features of a face of the user.

10. The detection system of claim 8, wherein the detection device comprises an optical device, the target comprises one or more objects on the user, and the characteristics comprise distinguishing features of the one or more objects on the user.

11. The detection system of claim 8, wherein the detection device comprises a transceiver, the target comprises a wireless beacon on the user, and the characteristics comprise a unique wireless signal outputted by the wireless beacon and detectable by the transceiver.

12. The detection system of claim 8, wherein the detection by the detection device of the characteristics of the target causes a resetting of the inactivity timer.

13. The detection system of claim 8, wherein the computer executes an initial login operation of the user in response to receiving user credentials and associates the characteristics of the target with the user credentials.

14. The detection system of claim 8, wherein the computer executes a full logout operation of the user at a conclusion of the logoff timer.

15. A computer program product comprising a computer readable storage medium having program instructions embodied therewith, the program instructions executable by a computer coupled to a detection device to cause:
capturing, by the detection device coupled to the computer, characteristics of a target;
looping, by the computer, an inactivity timer with respect to whether the characteristics are detected by the detection device;
automatically executing, by the computer, a temporary logoff operation of a user at a conclusion of the inactivity timer;
initiating, by the computer, an operation of a logoff timer in response to the execution of the temporary logoff operation;
automatically executing, by the computer, a login operation of the user when the characteristics are redetected by the detection device during the operation of the logoff timer.

16. The computer program product of claim 15, wherein the detection device comprises an optical device, the target comprises the user, and the characteristics comprise distinguishing features of a face of the user.

17. The computer program product of claim 15, wherein the detection device comprises an optical device, the target comprises one or more objects on the user, and the characteristics comprise distinguishing features of the one or more objects on the user.

18. The computer program product of claim 15, wherein the detection device comprises a transceiver, the target comprises a wireless beacon on the user, and the characteristics comprise a unique wireless signal outputted by the wireless beacon and detectable by the transceiver.

19. The computer program product of claim 15, wherein the detection by the detection device of the characteristics of the target causes a resetting of the inactivity timer.

20. The computer program product of claim 15, wherein the computer executes an initial login operation of the user in response to receiving user credentials and associates the characteristics of the target with the user credentials.
